(19) United States
(12) Patent Application Publication
(10) Pub. No.: US 2026/0216886 A1
(43) Pub. Date: Jul. 30, 2026

(54) MASTER DEVICE AND TEACHING SYSTEM

(71) Applicant: SINTOKOGIO, LTD., Nagoya-shi, Aichi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi, Aichi (JP)

(21) Appl. No.: 19/144,679

(22) PCT Filed: Dec. 8, 2023
(86) PCT No.: PCT/JP2023/043930

§ 371 Date: Jun. 30, 2025

(30) Foreign Application Priority Data
Mar. 29, 2023 (JP) 2023-054288

(51) Int. Cl. B25J 13/02; B25J 3/00; B25J 9/00

(52) U.S. Cl. CPC B25J 13/02; B25J 3/00; B25J 9/0081

(57) ABSTRACT

A slave device is efficiently and highly accurately taught to move. To a fixed shaft provided to a base member a proximal end part of a first master arm is turnably coupled. A master motor including a rotor that is rotated by a turning movement of the first master arm is provided to the base member. A part of the first master arm is rotatably coupled, via a first coupling pin, to a first portion that is eccentric with respect to an axis of the rotor.

### TECHNICAL FIELD

The present invention relates to a master device which can be operated by finger operation by a user and to a teaching system.

### BACKGROUND ART

A teaching system that includes a master device and a slave device is used in various fields such as a mechanical field, an architectural field, and a medical field. An example of a master device that can be operated by finger operation by a user is disclosed in Patent Literature 1. The following is a brief description of a configuration of a master device in accordance with that related art.

To a base member (referred to as a head section in Patent Literature 1) of the master device in accordance with the related art, a proximal end part of a master arm (referred to as an operation section in Patent Literature 1) for teaching a slave device to move is coupled so as to be swingable about a swing shaft (referred to as a rotation shaft of the operation section in Patent Literature 1). The swing shaft is rotatably supported by the base member and is integrally coupled to a proximal end part of a lever.

The base member is provided with a master motor (referred to as a first rotation motor in Patent Literature 1), and the master motor includes a rotor (referred to as a rotation shaft of the first rotation motor in Patent Literature 1) rotated by a swinging operation of the master arm. To the swing shaft of the master arm, a main driving gear is integrally provided. To the rotor of the master motor, a driven gear which meshes with the main driving gear is integrally provided. In other words, the proximal end part, which is a part of the master arm, is coupled to the rotor of the master motor via the driven gear and the main driving gear in an interlocked fashion.

### CITATION LIST

### Patent Literature

### [Patent Literature 1]

Japanese Patent Application Publication, Tokukai, No. 2019-34002

### SUMMARY OF INVENTION

### Technical Problem

The master device in accordance with the related art has the configuration in which the master arm is coupled to the rotor of the master motor via the driven gear and the main driving gear in an interlocked fashion. As such, a backlash between the main driving gear and the driven gear causes a loss in force transmitted between the master arm and the rotor of the master motor and rattling between the master arm and the rotor of the master motor. This makes it difficult to, with use of the master device, efficiently and highly accurately teach the slave device to move.

As such, it is an object of an aspect of the present invention to: prevent a loss in force transmitted between a first master arm and a rotor of a master motor and rattling between the first master arm and the rotor of the master motor; and to, with use of a master device, efficiently and highly accurately teach a slave device to move.

### Solution to Problem

A master device in accordance with an aspect of the present invention includes: a fixed shaft provided to a base member; a first master arm having a proximal end part turnably coupled to the fixed shaft and including a first insertion part into which a first finger of a user is to be inserted, the first master arm being configured to be turned by operation by the user to thereby teach a slave device to move; and a master motor provided to the base member and including a rotor that is rotated by a turning movement of the first master arm. A part of the first master arm is rotatably coupled, via a first coupling pin, to a first portion that is eccentric with respect to an axis of the rotor.

A teaching system in accordance with an aspect of the present invention includes: a master device in accordance with an aspect of the present invention; a slave device that operates in accordance with a turning movement of the first master arm; and a control section that controls a movement of the slave device with reference to a rotation angle and/or a torque of the rotor, the rotation angle and the torque being in accordance with the turning movement of the first master arm.

### Advantageous Effects of Invention

An aspect of the present invention makes it possible to: prevent a loss in force transmitted between a first master arm and a rotor of a master motor and rattling between the first master arm and the rotor of the master motor; and to, with use of a master device, efficiently and highly accurately teach a slave device to move.

### BRIEF DESCRIPTION OF DRAWINGS

FIG. 1 is a schematic view illustrating a teaching system in accordance with an embodiment of the present invention.

FIG. 2 is a schematic front view of a master device or a training device in accordance with the embodiment of the present invention.

FIG. 3 is a schematic left side view of the master device or the training device in accordance with the embodiment of the present invention.

FIG. 4 is a schematic right side view of the master device or the training device in accordance with the embodiment of the present invention.

FIG. 5 is a schematic perspective view of the master device or the training device in accordance with the embodiment of the present invention as viewed from a left oblique front.

FIG. 6 is a schematic perspective view of the master device or the training device in accordance with the embodiment of the present invention as viewed from a right oblique front.

FIG. 7 is a schematic view taken along a line VII-VII in FIG. 3.

FIG. 8 is a schematic perspective view of the master device or the training device in accordance with the embodiment of the present invention, the schematic perspective view illustrating finger operation by a user or training of another user.

FIG. 9 is a schematic perspective view of a master device or a training device in accordance with a variation of the embodiment of the present invention, the schematic perspective view illustrating finger operation by a user or training of another user.

FIG. 10 is a block diagram illustrating the teaching system in accordance with the embodiment of the present invention.

### DESCRIPTION OF EMBODIMENTS

The following description will discuss a present embodiment with reference to drawings. The symbols “FF”, “FR”, “L”, “R”, “U”, and “D” in the drawings refer to frontward, rearward, leftward, rightward, upward, and downward directions, respectively.

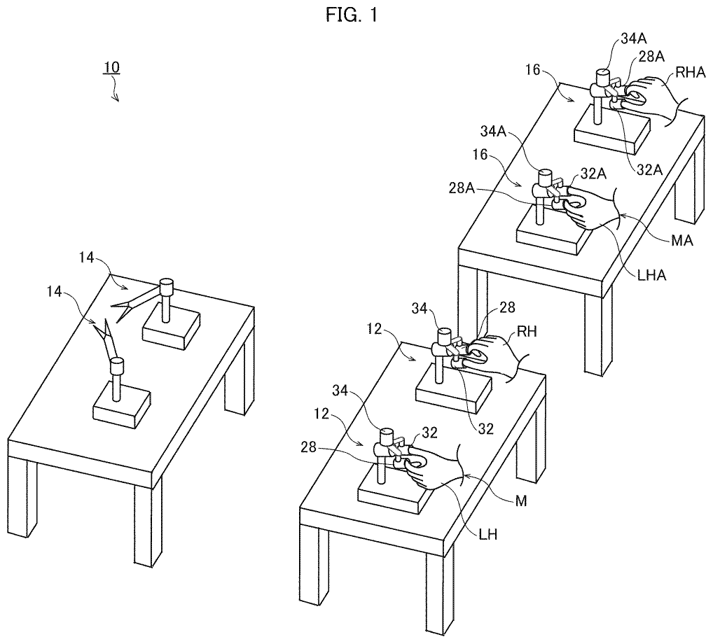

As illustrated in FIG. 1, a teaching system 10 in accordance with an embodiment of the present invention includes a pair of master devices 12 which can be operated by finger operation by a user M. One of the pair of master devices 12 can be operated with a right hand RH of the user M, and the other of the master devices 12 can be operated with a left hand LH of the user M. The pair of master devices 12 have the same configuration except for being bilaterally symmetrical to each other.

The teaching system 10 includes a pair of clamping devices 14 which grip an object (not illustrated). The pair of clamping devices 14 are slave devices which move in accordance with operation of the pair of master devices 12. One of the pair of clamping devices 14 makes a gripping movement or an ungripping movement in accordance with a movement of the one of the master devices 12. The other of the pair of clamping devices 14 makes a gripping movement or an ungripping movement in accordance with a movement of the other of the master devices 12. Each of the clamping devices 14 may include a clamp sensor (not illustrated) which detects a gripping force applied at the time when the object is gripped.

The teaching system 10 includes a pair of training devices 16 for training another user MA on finger operation, and the pair of training devices 16 are slave devices which move in accordance with operation of the pair of master devices 12. One of the pair of training devices 16 trains a right hand RHA of the another user MA by making a movement that mimics a movement of the one of the master devices 12. The other of the pair of training devices 16 trains a left hand LHA of the another user MA by making a movement that mimics a movement of the other of the master devices 12. The pair of training devices 16 have the same configuration except for being bilaterally symmetrical to each other.

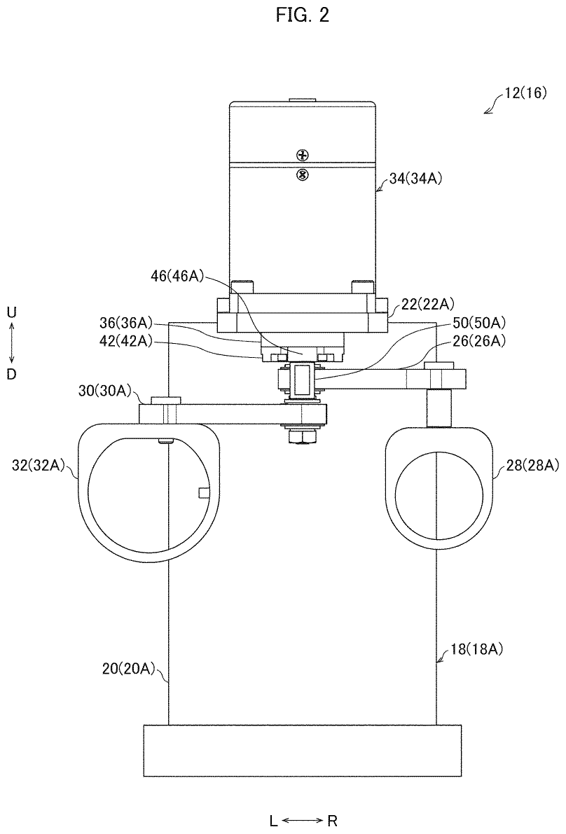

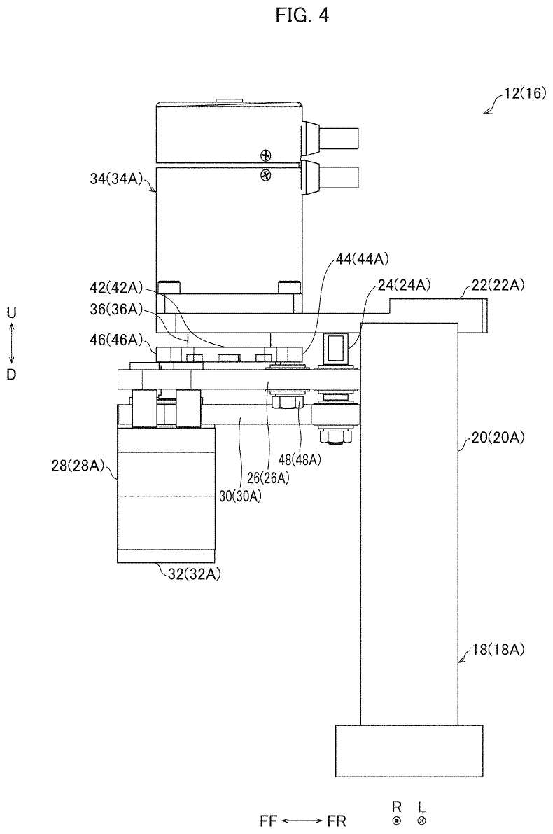

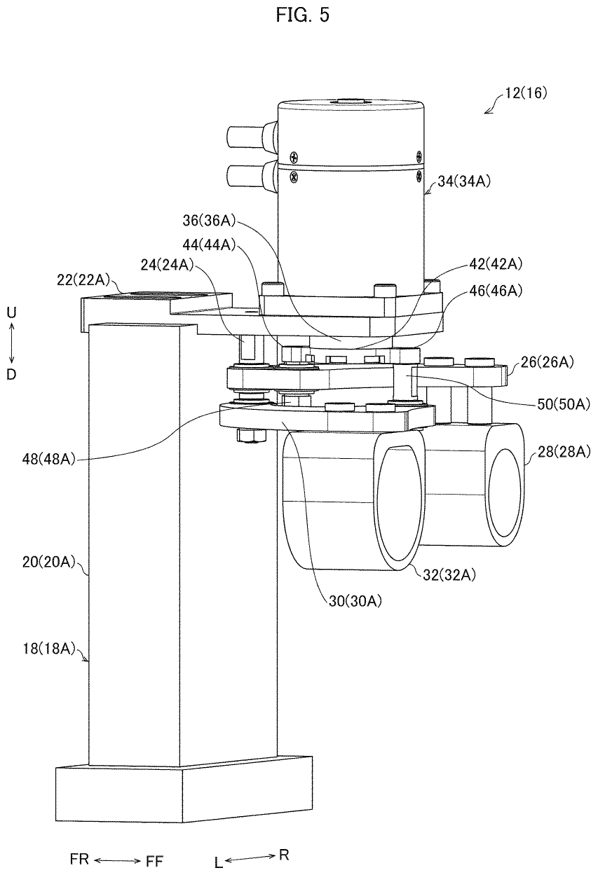

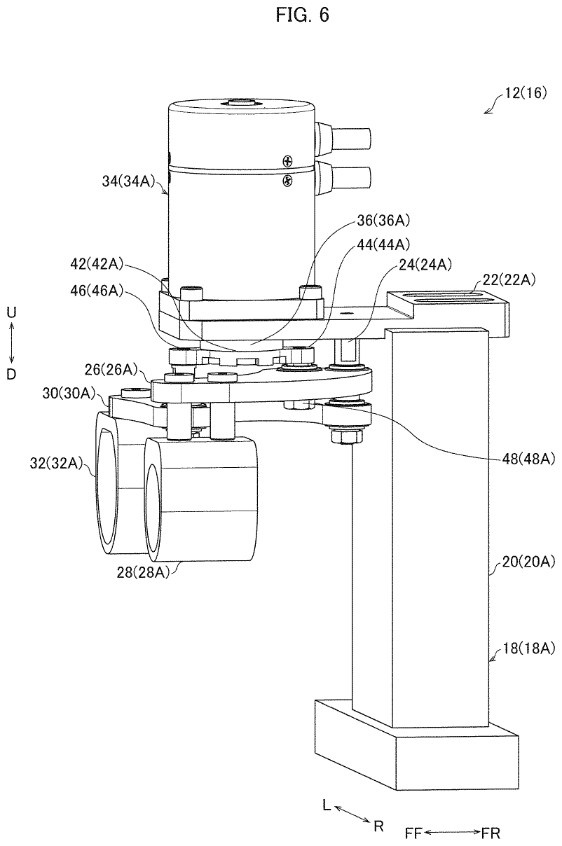

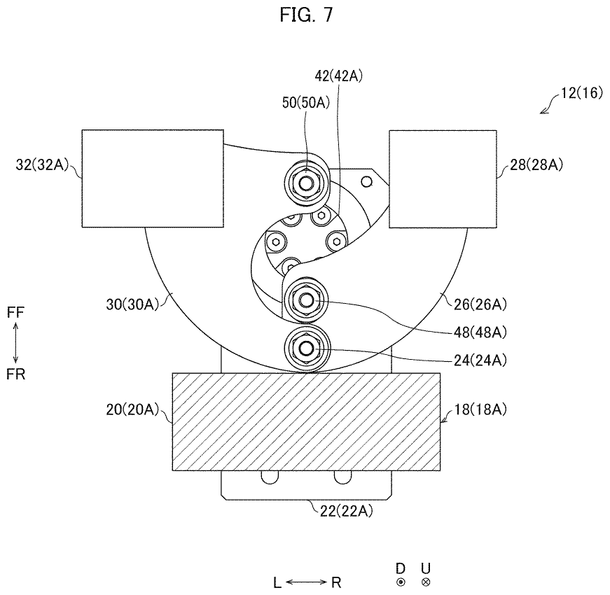

The following description will discuss a specific configuration of each master device 12, with reference to FIGS. 2 to 9.

As illustrated in FIGS. 2 to 6, the master device 12 includes a base member 18, and the base member 18 includes a support pillar 20 and a support plate 22 that is provided to the support pillar 20 so as to protrude horizontally. A position of the support plate 22 may be adjusted frontward and rearward and/or upward and downward relative to the support pillar 20.

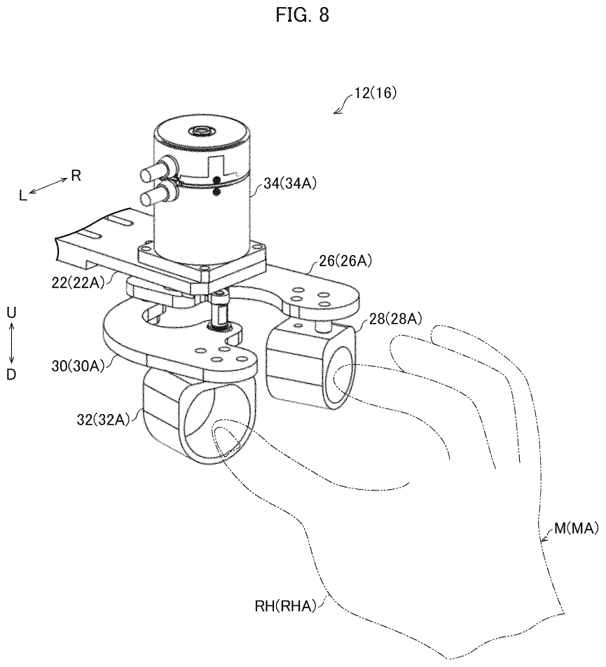

As illustrated in FIGS. 2 to 8, a fixed shaft 24 is provided to the support plate 22 so as to hang down from the support plate 22. To the fixed shaft 24, a proximal end part of a first master arm 26 is turnably coupled, the first master arm 26 being configured to teach the clamping device 14 and/or the training device 16 to move. The first master arm 26 is horizontally turned about an axis of the fixed shaft 24. The first master arm 26 is operated by the user M so as to be turned horizontally. The first master arm 26 includes, on a distal end-side thereof, a first insertion part 28 into which an index finger, which serves as a first finger, of the user M is to be inserted (see FIG. 8).

To the fixed shaft 24, a proximal end part of a second master arm 30 is turnably coupled, the second master arm 30 being configured to teach the clamping device 14 and/or the training device 16 to move. The second master arm 30 is horizontally turned about the axis of the fixed shaft 24 in synchronization with the first master arm 26. The second master arm 30 is operated by the user M so as to be turned horizontally in synchronization with the first master arm 26. The second master arm 30 includes, on a distal end-side thereof, a second insertion part 32 into which a thumb, which serves as a second finger, of the user M is to be inserted (see FIG. 8).

To the support plate 22, a master motor 34 is provided. The master motor 34 is a direct drive motor. The master motor 34 is provided above the first master arm 26 and the second master arm 30. The master motor 34 includes a rotor 36 which is rotated by turning movements of the first master arm 26 and the second master arm 30. The master motor 34 has an encoder 38 (see FIG. 10) which detects a rotation angle of the rotor 36. In the vicinity of the master motor 34, an ammeter (see FIG. 10) which measures an electric current of the master motor 34 is provided.

To the rotor 36, a connection member 42 having a disk-like shape is provided so as to be concentric and integral with the rotor 36. The connection member 42 includes a first eccentric part 44 which is eccentric with respect to an axis of the rotor 36 and which serves as a first portion. The connection member 42 includes a second eccentric part 46 which is eccentric with respect to the axis of the rotor 36 and which serves as a second portion different from the first portion. The first eccentric part 44 and the second eccentric part 46 are arranged in 180° rotational symmetry about the axis of the rotor.

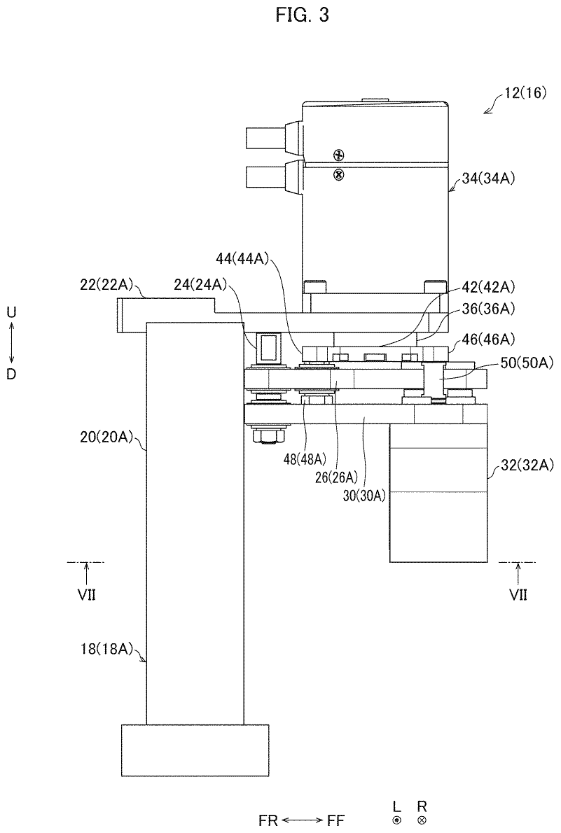

As illustrated in FIGS. 3 to 7, the vicinity of the proximal end part, which is a part of the first master arm 26, is rotatably coupled to the first eccentric part 44 of the connection member 42 via a first coupling pin 48. The first coupling pin 48 is fixed to the first eccentric part 44 of the connection member 42 and inserted into a long hole formed in the vicinity of the proximal end part of the first master arm 26. The vicinity of the second insertion part 32, which is a part of the second master arm 30, is rotatably coupled to the second eccentric part 46 of the connection member 42 via a second coupling pin 50. The second coupling pin 50 is fixed to the second eccentric part 46 of the connection member 42 and inserted into a long hole formed in the vicinity of the second insertion part 32 of the second master arm 30. The first coupling pin 48 and the second coupling pin 50 are arranged in 180° rotational symmetry about the axis of the rotor 36 (an axis of the connection member 42).

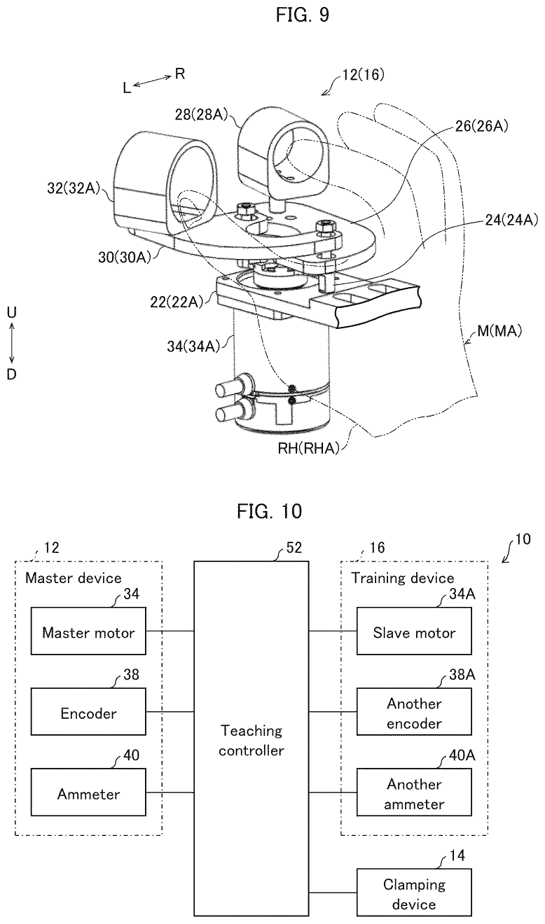

As described above, the master motor 34 is provided above the first master arm 26 and the second master arm 30. However, the master motor 34 may be provided below the first master arm 26 and the second master arm 30 as illustrated in FIG. 9.

The following description will discuss, with reference to FIGS. 1 to 9, the training devices 16 which serve as slave As illustrated in FIGS. 1 to 6, the training devices 16 have the same configuration as the master devices 12 except for being used as slave devices. Specifically, each training device 16 includes another base member 18A which is spaced apart from the base member 18, and the another base member 18A includes another support pillar 20A and another support plate 22A that is provided to the another support pillar 20A so as to protrude horizontally.

As illustrated in FIGS. 1 to 8, another fixed shaft 24A is provided to the another support plate 22A so as to hang down from the another support plate 22A. To the another fixed shaft 24A, a proximal end part of a first slave arm 26A is turnably coupled. The first slave arm 26A is horizontally turned about an axis of the another fixed shaft 24A. The first slave arm 26A includes, on a distal end-side thereof, another first insertion part 28A into which an index finger, which serves as a first finger, of another user MA is to be inserted (see FIG. 8).

To the another fixed shaft 24A, a proximal end part of a second slave arm 30A is turnably coupled. The second slave arm 30A is horizontally turned about the axis of the another fixed shaft 24A in synchronization with a turning movement of the first slave arm 26A. The second slave arm 30A includes, on a distal end-side thereof, another second insertion part 32A into which a thumb, which serves as a second finger, of the another user MA is to be inserted (see FIG. 8).

To the another support plate 22A, a slave motor 34A is provided. The slave motor 34A is a direct drive motor. The slave motor 34A is provided above the first slave arm 26A and the second slave arm 30A. The slave motor 34A includes another rotor 36A which is rotated in a manner mimicking a rotational movement of the rotor 36 of the master motor 34. The slave motor 34A has another encoder 38A (see FIG. 10) which detects a rotation angle of the another rotor 36A. In the vicinity of the slave motor 34A, another ammeter (see FIG. 10) which measures an electric current of the slave motor 34A is provided.

To the another rotor 36A, another connection member 42A having a disk-like shape is provided so as to be concentric and integral with the another rotor 36A. The another connection member 42A includes another first eccentric part 44A which is eccentric with respect to an axis of the another rotor 36A and which serves as another first portion. The another connection member 42A includes another second eccentric part 46A which is eccentric with respect to the axis of the another rotor 36A and which serves as another second portion different from the another first portion. The another first eccentric part 44A and the another second eccentric part 46A are arranged in 180° rotational symmetry about the axis of the another rotor 36A.

As illustrated in FIGS. 3 to 7, the vicinity of the proximal end part, which is a part of the first slave arm 26A, is rotatably coupled to the another first eccentric part 44A of the another connection member 42A via another first coupling pin 48A. The another first coupling pin 48A is fixed to the another first eccentric part 44A of the another connection member 42A and inserted into a long hole formed in the vicinity of the proximal end part of the first slave arm 26A. The vicinity of the another second insertion part 32A, which is a part of the second slave arm 30A, is rotatably coupled to the another second eccentric part 46A of the another connection member 42A via another second coupling pin 50A. The another second coupling pin 50A is fixed to the another second eccentric part 46A of the another connection member 42A and inserted into a long hole formed in the vicinity of the another second insertion part 32A of the second slave arm 30A. The another first coupling pin 48A and the another second coupling pin 50A are arranged in 180° rotational symmetry about the axis of the another rotor 36A (an axis of the another connection member 42A).

As described above, the slave motor 34A is provided above the first slave arm 26A and the second slave arm 30A. However, the slave motor 34A may be provided below the first slave arm 26A and the second slave arm 30A as illustrated in FIG. 9.

As illustrated in FIG. 10, the teaching system 10 includes a teaching controller 52 serving as a control section that controls the pair of master devices 12, the pair of clamping devices 14, and the pair of training devices 16. The teaching controller 52 includes: a memory (not illustrated) that stores, for example, a plurality of control programs for controlling movements of the pair of master devices 12, the pair of clamping devices 14, and the pair of training devices 16; and a microprocessor (not illustrated) that interprets and then executes the plurality of control programs.

The teaching controller 52 calculates a torque applied to the rotor 36, with reference to a change in electric current of the master motor 34. The teaching controller 52 calculates a torque applied to the another rotor 36A, with reference to a change in electric current of the slave motor 34A. The teaching controller 52 controls movements of the pair of clamping devices 14 with reference to rotation angles and/or torques of the rotors 36 of the pair of master devices 12 which rotation angles and torques are in accordance with turning movements of the first master arms 26. With reference to the rotation angles and/or the torques of the rotors 36 of the pair of master devices 12 which rotation angles and the torques are in accordance with the turning movements of the first master arms 26, the teaching controller 52 controls the pair of slave motors 34A so as to cause the pair of training devices 16 to make movements that mimic movements of the pair of master devices 12. The teaching controller 52 may control the master motors 34 of the pair of master devices 12 with reference to gripping forces of the pair of clamping devices 14.

In a case where finger operation by the user M causes a first master arm 26 and a second master arm 30 to turn in synchronization with each other so as to bring the first insertion part 28 and the second insertion part 32 closer to each other, the teaching controller 52 controls a corresponding clamping device 14 to make a gripping movement. In a case where finger operation by the user M causes the first master arm 26 and the second master arm 30 to turn in synchronization with each other so as to bring the first insertion part 28 and the second insertion part 32 away from each other, the teaching controller 52 controls the clamping device 14 to make an ungripping movement. Further, in a case where finger operation by the user M causes the first master arm 26 and the second master arm 30 to turn in synchronization with each other, the teaching controller 52 controls a corresponding slave motor 34A so as to cause the first slave arm 26A and the second slave arm 30A to make movements in a mimicking manner in synchronization with each other.

The following description will discuss the effects of the embodiment of the present invention.

As illustrated in FIGS. 1 and 10, finger operation by the user M causes the first master arm 26 and the second master arm 30 to turn in synchronization with each other. Then, the teaching controller 52 controls the clamping device 14 and the training device 16, each of which serves as a slave device, with reference to a rotation angle and/or a torque of the rotor 36 which are/is in accordance with turning movements of the first master arm 26 and the second master arm 30. Thus, it is possible, by finger operation by the user M, to not only teach the clamping device 14 to make a desired movement but also teach the training device 16 to make a movement mimicking the master device 12.

As described above, the master device 12 is configured such that the vicinity of the proximal end part, which is a part of the first master arm 26, is rotatably coupled to the first eccentric part 44 of the connection member 42 via the first coupling pin 48. The vicinity of the second insertion part 32, which is a part of the second master arm 30, is rotatably coupled to the second eccentric part 46 of the connection member 42 via the second coupling pin 50. As such, it is possible, without using a gear mechanism which can cause a backlash, to couple the part of the first master arm 26 and the part of the second master arm 30 to the rotor 36 in an interlocked fashion. This makes it possible to prevent a loss in force transmitted between the first master arm 26 and the rotor 36 and between the second master arm 30 and the rotor 36. It is possible to prevent rattling between the first master arm 26 and the rotor 36 and between the second master arm 30 and the rotor 36. As a result, it is possible to, with use of the master device 12, efficiently and highly accurately teach the clamping device 14 and the training device 16, each of which serves as a slave device, to move.

As described above, the master device 12 is configured such that the first master arm 26 includes, on the distal end-side thereof, the first insertion part 28 into which the index finger, which serves as the first finger, of the user M is to be inserted. The second master arm 30 includes, on the distal end-side thereof, the second insertion part 32 into which the thumb, which serves as the second finger, of the user M is to be inserted. As such, it is possible, by finger operation by the user M with the two fingers, to not only stably rotate the rotor 36 in forward and reverse directions but also causing the clamping device 14 to reproduce a human movement.

As described above, the master device 12 is configured such that the master motor 34 is a direct drive motor. This eliminates the need to provide an intermediate device such as a decelerator between the rotor 36 and the first master arm 26 or between the rotor 36 and the second master arm 30. This makes it possible to highly accurately transmit force from the first master arm 26 to the rotor 36 and from the second master arm 30 to the rotor 36, in comparison to a case in which the master motor 34 is a general motor.

As described above, the master device 12 is configured such that the first coupling pin 48 and the second coupling pin 50 are arranged in 180° rotational symmetry about the axis of the rotor 36. This makes it possible to sufficiently secure a range of rotation of the rotor 36 and to improve operability in finger operation by the user M.

Aspects of the present invention can also be expressed as follows:

A master device in accordance with Aspect 1 of the present invention includes: a fixed shaft provided to a base member; a first master arm having a proximal end part turnably coupled to the fixed shaft and including a first insertion part into which a first finger of a user is to be inserted, the first master arm being configured to be turned by finger operation by the user to thereby teach a slave device to move; and a master motor provided to the base member and including a rotor that is rotated by a turning movement of the first master arm. A part of the first master arm is rotatably coupled, via a first coupling pin, to a first portion that is eccentric with respect to an axis of the rotor.

According to the above configuration, as described above, the part of the first master arm is rotatably coupled, via the first coupling pin, to the first portion that is eccentric with respect to the axis of the rotor. As such, it is possible, without using a gear mechanism which can cause a backlash, to couple the part of the first master arm to the rotor in an interlocked fashion. This makes it possible to: prevent a loss in force transmitted between the first master arm and the rotor and rattling between the first master arm and the rotor; and to, with use of the master device, efficiently and highly accurately teach the slave device to move.

A master device in accordance with Aspect 2 of the present invention may be configured such that, in Aspect 1 above, the master motor is a direct drive motor.

According to the above configuration, the master motor is a direct drive motor. This eliminates the need to provide an intermediate device such as a decelerator between the rotor and the first master arm. This makes it possible to highly accurately transmit force from the first master arm to the rotor, in comparison to a case in which the master motor is a general motor.

A master device in accordance with Aspect 3 of the present invention may be configured such that, in Aspect 1 or 2 above, the master device further includes: a second master arm having a proximal end part turnably coupled to the fixed shaft and including a second insertion part into which a second finger of the user is to be inserted, the second master arm being configured to be turned by finger operation by the user in synchronization with the first master arm to thereby teach the slave device to move, a part of the second master arm being rotatably coupled, via a second coupling pin, to a second portion that is eccentric with respect to the axis of the rotor.

According to the above configuration, as described above, the second master arm has the proximal end part turnably coupled to the fixed shaft and includes the second insertion part into which the second finger of the user is to be inserted. As such, it is possible, by finger operation by the user with the two fingers, to stably rotate the rotor in forward and reverse directions.

Further, as described above, the part of the second master arm is rotatably coupled, via the second coupling pin, to the second portion that is eccentric with respect to the axis of the rotor. As such, it is possible, without using a gear mechanism which can cause a backlash, to couple the second master arm to the rotor in an interlocked fashion.

A master device in accordance with Aspect 4 of the present invention may be configured such that, in Aspect 3 above, the first coupling pin and the second coupling pin are arranged in 180° rotational symmetry about the axis of the rotor.

According to the above configuration, it is possible to sufficiently secure a range of rotation of the rotor and to improve operability in finger operation by the user.

A teaching system in accordance with Aspect 5 of the present invention includes: a master device in accordance with any one of Aspects 1 to 4 above; a slave device that operates in accordance with a turning movement of the first master arm; and a control section that controls a movement of the slave device with reference to a rotation angle and/or a torque of the rotor, the rotation angle and the torque being in accordance with the turning movement of the first master arm.

According to the above configuration, finger operation by the user causes the first master arm to turn. Then, the control section controls a movement of the slave device with reference to a rotation angle and/or a torque of the rotor, the rotation angle and the torque being in accordance with the turning movement of the first master arm. This makes it possible, by finger operation by the user, to teach the slave device to make a desired movement.

A teaching system in accordance with Aspect 6 of the present invention may be configured such that, in Aspect 5 above, the slave device includes another fixed shaft provided to another base member that is spaced apart from the base member, a first slave arm having a proximal end part turnably supported by the another fixed shaft and including another first insertion part into which a first finger of another user is to be inserted, and a slave motor provided to the another base member and including another rotor that is rotated in accordance with the turning movement of the first master arm. A part of the first slave arm may be rotatably coupled, via another first coupling pin, to a portion that is eccentric with respect to an axis of the another rotor.

According to the above configuration, finger operation by the user causes the first master arm to turn. Then, the control section controls the slave motor with reference to a rotation angle and/or a torque of the rotor, the rotation angle and the torque being in accordance with the turning movement of the first master arm. This makes it possible to, by finger operation by the user, teach the slave device to make a movement mimicking the master device.

### Additional Remarks

The present invention is not limited to the embodiments above, but can be altered by a skilled person in the art in various manners within the scope of the claims. The present invention also encompasses, in its technical scope, any embodiment derived by combining technical means disclosed in differing embodiments as appropriate.

### REFERENCE SIGNS LIST

10: teaching system, 12: master device, 14: clamping device (slave device), 16: training device (slave device), 18: base member, 20: support pillar, 22: support plate, 24: fixed shaft, 26: first master arm, 28: first insertion part, 30: second master arm, 32: second insertion part, 34: master motor, 36: rotor, 38: encoder, 40: torque sensor, 42: connection member, 44: first eccentric part (first portion), 46: second eccentric part (second portion), 48: first coupling pin, 50: second coupling pin, 18A: another base member, 20A: another support pillar, 22A: another support plate, 24A: another fixed shaft, 26A: first slave arm, 28A: another first insertion part, 30A: second slave arm, 32A: another second insertion part, 34A: slave motor, 36A: another rotor, 38A: another encoder, 40A: another torque sensor, 42A: another connection member, 44A: another first eccentric part (another first portion), 46A: another second eccentric part (another second portion), 48A: another first coupling pin, 50A: another second coupling pin, 52: teaching controller (control section)

1. A master device, comprising:
a fixed shaft provided to a base member;
a first master arm having a proximal end part turnably coupled to the fixed shaft and including a first insertion part into which a first finger of a user is to be inserted, the first master arm being configured to be turned by finger operation by the user to thereby teach a slave device to move; and
a master motor provided to the base member and including a rotor that is rotated by a turning movement of the first master arm,
a part of the first master arm being rotatably coupled, via a first coupling pin, to a first portion that is eccentric with respect to an axis of the rotor.

2. The master device as set forth in claim 1, wherein the master motor is a direct drive motor.

3. The master device as set forth in claim 1, further comprising:
a second master arm having a proximal end part turnably coupled to the fixed shaft and including a second insertion part into which a second finger of the user is to be inserted, the second master arm being configured to be turned by finger operation by the user in synchronization with the first master arm to thereby teach the slave device to move,
a part of the second master arm being rotatably coupled, via a second coupling pin, to a second portion that is eccentric with respect to the axis of the rotor.

4. The master device as set forth in claim 3, wherein the first coupling pin and the second coupling pin are arranged in 180° rotational symmetry about the axis of the rotor.

5. A teaching system, comprising:
a master device recited in claim 1;
a slave device that operates in accordance with a turning movement of the first master arm; and
a control section that controls a movement of the slave device with reference to a rotation angle and/or a torque of the rotor, the rotation angle and the torque being in accordance with the turning movement of the first master arm.

6. The teaching system as set forth in claim 5, wherein:
the slave device includes
another fixed shaft provided to another base member that is spaced apart from the base member,
a first slave arm having a proximal end part turnably supported by the another fixed shaft and including another first insertion part into which a first finger of another user is to be inserted, and
a slave motor provided to the another base member and including another rotor that is rotated in accordance with the turning movement of the first master arm; and
a part of the first slave arm is rotatably coupled, via another first coupling pin, to a portion that is eccentric with respect to an axis of the another rotor.
